(19) United States
(12) Patent Application Publication
(10) Pub. No.: US 2006/0009212 A1
(43) Pub. Date: Jan. 12, 2006

(54) Apparatus and method for signal processing in a handover in a BWA communication

(75) Inventors: Jeong-Heon Kim, Anyang-si (KR); Jae-Ho Jeon, Seongnam-si (KR); Seung-Joo Maeng, Seongnam-si (KR); Ji-Ho Jang, Seoul (KR); Myung-Kwang Byun, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/167,664

(22) Filed: Jun. 27, 2005

(30) Foreign Application Priority Data
Jun. 25, 2004 (KR) 48447/2004

(51) Int. Cl. H04Q 7/20

(52) U.S. Cl. 455/423

(57) ABSTRACT

An apparatus and method for processing received signals in a handover of a MS in a BWA communication system including a plurality of BSs capable of providing a service to the MS. According to the method, the MS receives signals of different BSs and detects preambles for each BS from the received signals. Further, the MS measures channel quality information corresponding to each of the detected preambles and compares the measured channel quality information with a preset threshold value. Further, the MS processes the signals received from the different BSs based on a result obtained by comparing the measured channel quality information with the preset threshold value.

### PRIORITY

This application claims priority to an application entitled “Apparatus and Method for Signal Processing in Handover in BWA Communication System” filed in the Korean Intellectual Property Office on Jun. 25, 2004 and assigned Serial No. 2004-48447, the contents of which are hereby incorporated by reference.

### BACKGROUND OF THE INVENTION

1. Field of the Invention

The present invention relates generally to a Broadband Wireless Access (BWA) communication system, and more particularly to an apparatus and a method for processing received signals in a handover of a Mobile Station (MS) in a BWA communication system using an Orthogonal Frequency Division Multiple Access (OFDMA) scheme.

2. Description of the Related Art

Generally, a representative system of a wireless communication system includes a mobile communication system using a cellular communication scheme. Such a mobile communication system uses a multiple access scheme in order to simultaneously communicate with a plurality of users. A Time Division Multiple Access (TDMA) scheme and a Code Division Multiple Access (CDMA) scheme are used as the multiple access scheme used in the mobile communication system as described above.

With the rapid development of communication technology, a mobile communication system using the CDMA scheme has developed into a system capable of transmitting packet data at high speed from a system providing voice-based communication.

However, codes, which are resources in the CDMA scheme, have reached a limit in use thereof, such that it becomes more and more difficult to transmit multimedia data. Accordingly, it is required to provide a multiple access scheme capable of identifying many more users and transmitting more data to the identified users. In order to satisfy such requirements, the idea of a BWA communication system using an OFDMA scheme is gathering support.

The OFDMA scheme transmits/receives data at high speed using multiple sub-carriers that maintain orthogonality or a sub-channel including at least one sub-carrier.

A BWA communication system using the OFDMA scheme accommodates the mobility of a MS. Accordingly, a handover must be performed to facilitate smooth and continuous communication, regardless of the movement of the MS.

A handover denotes that a channel is maintained for smooth communication even when a MS during communication moves between Base Stations (BSs). The handover may be largely classified into hard handover and soft handover. In the hard handover, a channel of a serving BS, which is currently communicating with a MS, is blocked when the MS during communication moves between BSs, and the channel of a target BS to which the MS is to be handed over is quickly connected, so that continuity of communication is guaranteed. In the soft handover, both a channel of a serving BS currently communicating with a MS and a channel of a target BS to which the MS is to be handed over are maintained when the MS during communication moves between BSs, and the channel of the serving BS is then released after the MS completely moves to a region of the target BS. That is, when the MS moves between different regions, in each of which a communication service is being provided to the MS, the soft handover enables the MS to connect to the channel of the target BS without communication interruption.

As described above, the handover may be classified into a hard handover and a soft handover. Currently, the hard handover has been generalized in the BWA communication scheme. However, using the hard handover may cause interruption of signals. Although the interruption of signals occurs during a very short time period, it may be disadvantageous in the BWA communication system targeting stable transmission/reception of high-speed data. Accordingly, the BWA communication system must consider the soft handover. However, a detailed scheme for the soft handover has not yet been proposed for the BWA communication system.

Hereinafter, a description will be given on assumption that the soft handover is performed in the BWA communication system. When the soft handover is performed, a channel may be classified into an uplink and a downlink channel in data transmission/reception between a MS and BSs. More specifically, in the downlink, the MS receives signals from a plurality of BSs. Therefore, the complexity of the MS receiving and processing the signals from the BSs increases and system management for handover cannot be efficiently performed. Consequently, when the soft handover is performed, data transmission/reception is not efficiently performed.

As described above, a detailed scheme for performing the soft handover between BSs is necessary for the BWA communication system. Further, when the soft handover is performed, it is necessary to provide a scheme for efficiently performing data transmission/reception.

### SUMMARY OF THE INVENTION

Accordingly, the present invention has been designed to solve the above and other problems occurring in the prior art. It is an object of the present invention is to provide an apparatus and a method for signal processing during a soft handover in a BWA communication system.

It is another object of the present invention is to provide an apparatus and a method for signal processing for efficiently transmitting and receiving data in a handover in a BWA communication system.

In order to accomplish the above and other objects, according to one aspect of the present, there is provided a method for processing received signals in a handover of a Mobile Station (MS) in a Broadband Wireless Access (BWA) communication system including a plurality of Base Stations (BSs) capable of providing a service to the MS. The method comprises the steps of: receiving signals of different BSs; detecting preambles for each BS from the received signals; measuring channel quality information corresponding to each of the detected preambles; comparing the measured channel quality information with a preset threshold value; and processing the signals received from the different BSs based on a result obtained by comparing the measured channel quality information with the preset threshold value.

According to another aspect of the present, there is provided a method for processing received signals in a handover of a Mobile Station (MS) in a Broadband Wireless Access (BWA) communication system including a plurality of Base Stations (BSs) capable of providing a service to the MS. The method comprises the steps of: receiving signals of different BSs; detecting preambles for each of the BSs from the received signals; measuring a first measurement value and a second measurement value corresponding to each of the detected preambles; comparing each of the measurement values with a preset threshold value; processing all of the signals received from the BSs, when the first measurement value and the second measurement value exceed the preset threshold value; and selectively processing the signals received from the BSs according to a predetermined signal processing scheme, when the first measurement value and the second measurement value do not exceed the preset threshold value.

According to yet another aspect of the present, there is provided an apparatus for processing received signals in a handover in a Broadband Wireless Access (BWA) communication system including a plurality of Base Stations (BSs) capable of providing a service to the MS. The apparatus comprises a preamble detector for receiving signals of different BSs and detecting preambles for each of the BSs from the received signals; a channel quality information measurer for measuring channel quality information corresponding to each of the detected preamble; a signal processing determiner for comparing the measured channel quality information with a preset threshold value, and determining whether to process the signals received from the different BSs based on a result obtained by comparing the measured channel quality information with the preset threshold value; and a signal processor for processing the signals received from the different BSs, based on whether to process the signals.

### BRIEF DESCRIPTION OF THE DRAWINGS

The above and other objects, features, and advantages of the present invention will be more apparent from the following detailed description taken in conjunction with the accompanying drawings, in which:

FIG. 1 illustrates the use of frequency resources in a BWA communication system;

FIG. 2 is a diagram illustrating an allocation of the same sub-channel in a same time slot by BSs and signal transmission based on the allocation according to an embodiment of the present invention;

FIG. 3 is a diagram illustrating an allocation of different sub-channels in a same time slot by BSs and signal transmission based on the allocation according to an embodiment of the present invention;

FIG. 4 is a diagram illustrating an allocation of different sub-channels in different time slots by BSs and signal transmission based on the allocation according to an embodiment of the present invention;

FIG. 5 is a flow diagram illustrating an operation method of a MS employed a soft combining scheme in handover in a BWA communication system according to one embodiment of the present invention;

FIG. 6 is a flow diagram illustrating an operation method of a MS in a soft combining scheme in handover in a BWA communication system according to another embodiment of the present invention;

FIG. 7 is a flow diagram illustrating an operation method of a MS in a selection scheme in handover in a BWA communication system according to further another embodiment of the present invention;

FIG. 8 is a flow diagram illustrating an operation method of a MS in a selection diversity scheme in handover in a BWA communication system according to further another embodiment of the present invention;

FIG. 9 is a block diagram illustrating a MS in a soft combining scheme in handover in a BWA communication system according to an embodiment of the present invention; and

FIG. 10 is a block diagram illustrating a MS in a selection diversity scheme in handover in a BWA communication system according to an embodiment of the present invention.

### DETAILED DESCRIPTION OF THE PREFERRED EMBODIMENT

Preferred embodiments of the present invention will be described in detail herein below with reference to the accompanying drawings. The same reference numerals are used to designate the same elements as those shown in other drawings. Additionally, in the following description of the present invention, a detailed description of known functions and configurations incorporated herein will be omitted when it may obscure the subject matter of the present invention.

The present invention proposes a signal processing scheme during a handover in a Broadband Wireless Access (BWA) communication system using an Orthogonal Frequency Division Multiple Access (OFDMA) scheme. As such, a Mobile Station (MS) detects preambles from signals received from a plurality of Base Stations (BSs), compares channel quality information, e.g., Carrier-to-Interference and Noise Ratios (CINRs), corresponding to each of the preambles, with a preset threshold value, and processes the signals received from the BSs according to a result obtained from the comparison.

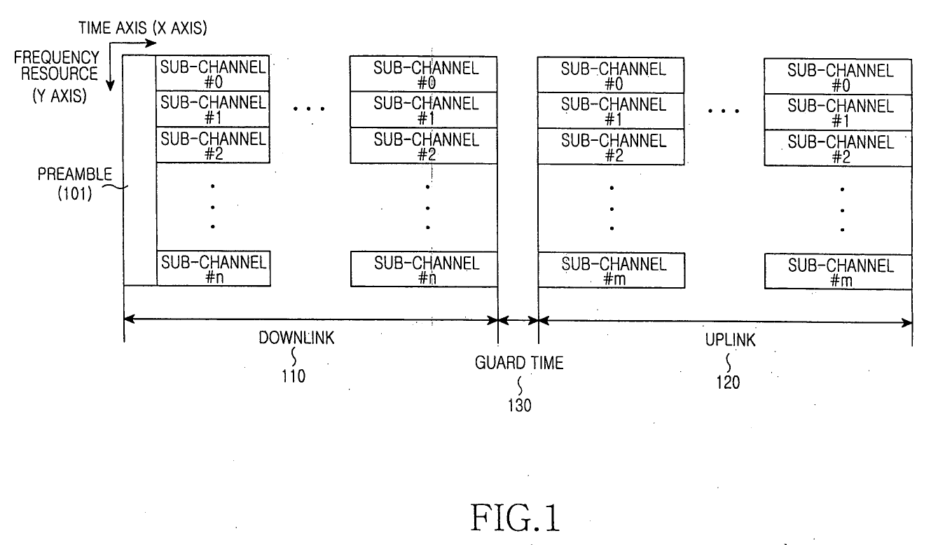

FIG. 1 illustrates the use of frequency resources in a BWA communication system. Referring to FIG. 1, an x axis denotes time and a y axis denotes frequency resources in the graph. The frequency resources denote one sub-channel including a plurality of frequency resources, and each sub-channel includes at least one sub-carrier.

A downlink 110 includes (n+1) sub-channels and an uplink 120 includes (m+1) sub-channels. The sub-channel may be constructed by a plurality of adjacent sub-carriers or by a plurality of non-adjacent sub-carriers.

FIG. 1 illustrates only an exemplary case where one sub-channel is constructed by a plurality of adjacent sub-carriers, but this does not mean that the sub-channel is actually constructed in this manner. That is, in FIG. 1 and other drawings, the sub-channel does not represent an actual location of a physical sub-carrier within a frequency band, but represents a set of sub-carriers selected through a specific method within the frequency band.

As illustrated in FIG. 1, the downlink 110 includes a transmission interval of a preamble 101 for a channel estimation of a MS, a BS detection, etc. Further, a guard time 130 is located between the downlink 110 and the uplink 120. The guard time 130 is time for distinguishing the downlink 110 from the uplink 120.

Hereinafter, a downlink soft handover method applied to a detailed embodiment of the present invention will be described. When a handover is performed, a soft combining scheme or a selection diversity scheme is applied in the downlink soft handover method. Further, a method for processing signals by using channel quality information extracted from a preamble will be described.

However, before describing the present invention, the soft handover method in a downlink will be described. Further, the soft handover method will be described in two embodiments, i.e., a case where cells or sectors of all BSs use the same sub-channelization method and a case where the cells or the sectors of all BSs use different sub-channelization methods. When all BSs use the same sub-channelization method, all sub-channels with the same index of each BS use the same sub-carriers. Further, when all BSs use the different sub-channelization methods in the downlink, it is noted that actual locations of used sub-carriers are different even though logical channel numbers between sub-channels are equal.

In the following description, even when cell A is replaced with a sector A and cell B is replaced with a sector B, it is noted that application of the present invention is possible. The sector A and the sector B exist in the same cell.

1. The Soft Handover Method when all BSs use the Same Sub-Channelization Method

A. Allocation of the Same Sub-Channel in the Same Time Slot

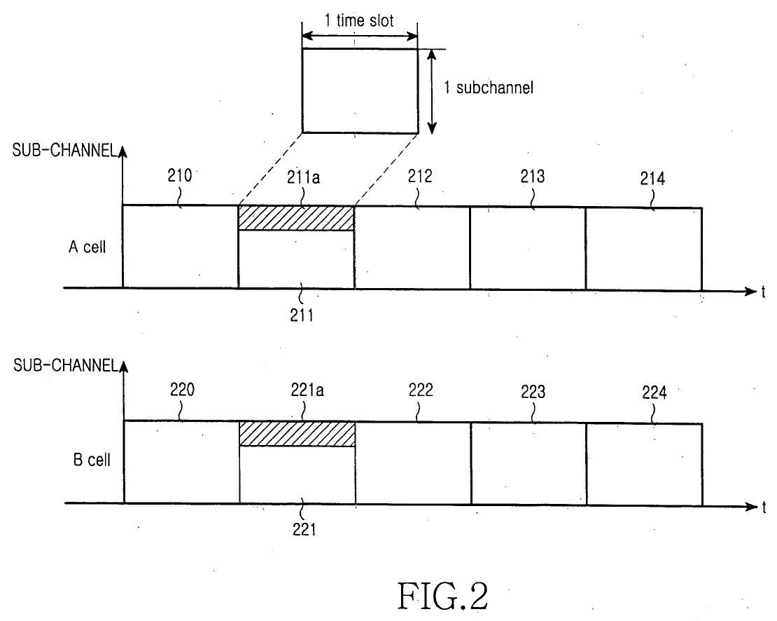

FIG. 2 is a diagram illustrating an allocation of the same sub-channel in the same time slot by BSs and signal transmission based on the allocation according to an embodiment of the present invention. Referring to FIG. 2, a BS of cell A allocates a sub-channel 211a to n MS during handover in a specific time slot 211 of multiple time slots 210 to 214 in a downlink frame. Further, a BS of cell B also allocates a sub-channel 221a to n MS during handover in a specific time slot 221 of multiple time slots 220 to 224 in a downlink frame.

The MS having received the same sub-channels in the same time slots has only to receive signals without distinguishing the signals of the BSs, similarly to when receiving the signals of one BS. That is, the BS of the cell A and the BS of the cell B broadcast the same allocation information (DL-MAP). Accordingly, if the MS receives the allocation information of either of the BS of the cell A or the BS of the cell B, the MS can receive all signals transmitted from the BS of the cell A and the BS of the cell B. Herein, the MS must recognize in advance that the same allocation information is being broadcasted from the BSs.

The MS can perform soft handover to one of the cells in consideration of intensities of signals from the cell A and signals from the cell B.

According to the sub-channel allocation and handover method as described above, latency is short, and inter-cell interference is reduced because the same sub-channel is used in the same time slot. Therefore, a coverage hole representing that a reception rate of n MS rapidly deteriorates can be reduced and channel estimation performance is better. Consequently, this method may also be applied to a broadcasting service.

B. Allocation of Different Sub-Channels in the Same Time Slot

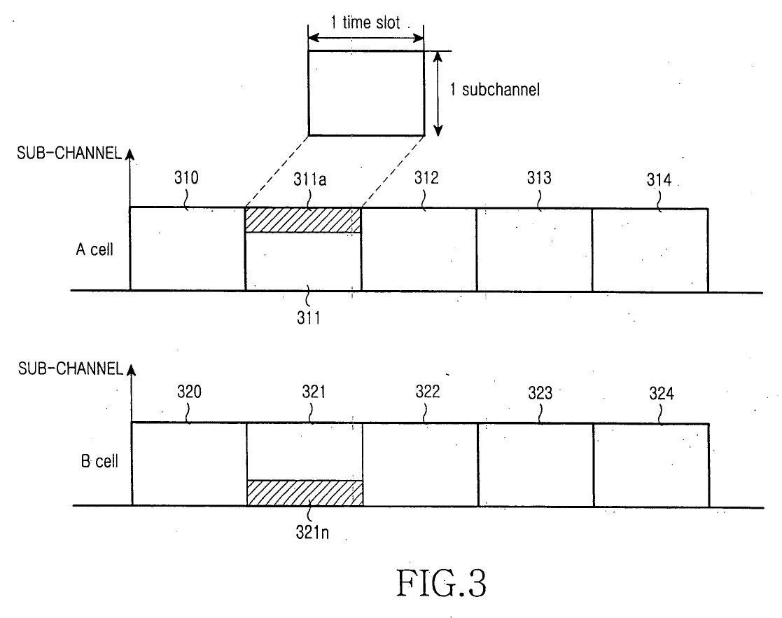

FIG. 3 is a diagram illustrating an allocation of the different sub-channels in the same time slot by BSs and signal transmission based on the allocation according to an embodiment of the present invention. Referring to FIG. 3, a BS of a cell A allocates a specific sub-channel 311a to an MS during handover in a specific time slot 311 of multiple time slots 310 to 314 in a downlink frame. Further, a BS of a cell B allocates a specific sub-channel 321n to an MS during handover in a specific time slot 321 of multiple time slots 320 to 324 in a downlink frame.

The sub-channels 311a and 321n exist in the same time slot, but are different sub-channels. The different sub-channel denotes a sub-channel constructed by different sub-channelization methods or a sub-channel constructed by different sub-carriers.

Accordingly, only when the MS receives all allocation information transmitted from the BS of the cell A and the BS of the cell B, the MS can identify locations of the sub-channels 311a and 321n and receive data.

According to the method as described above, because data is transmitted in the same time slot, latency is short as described FIG. 2 and performance improvement by frequency diversity can be also achieved.

The allocation information of the BS of the cell A and the BS of the cell B may also be separately transmitted according to each BS, the allocation information of all BSs may also be transmitted from a serving BS, or the allocation information of all BSs may also be simultaneously transmitted from all BSs. Accordingly, the MS can receive data in a handover region after identifying, in advance, one of various transmission methods of the allocation information as described above.

C. Allocation of Different Sub-Channels in Different Time Slots

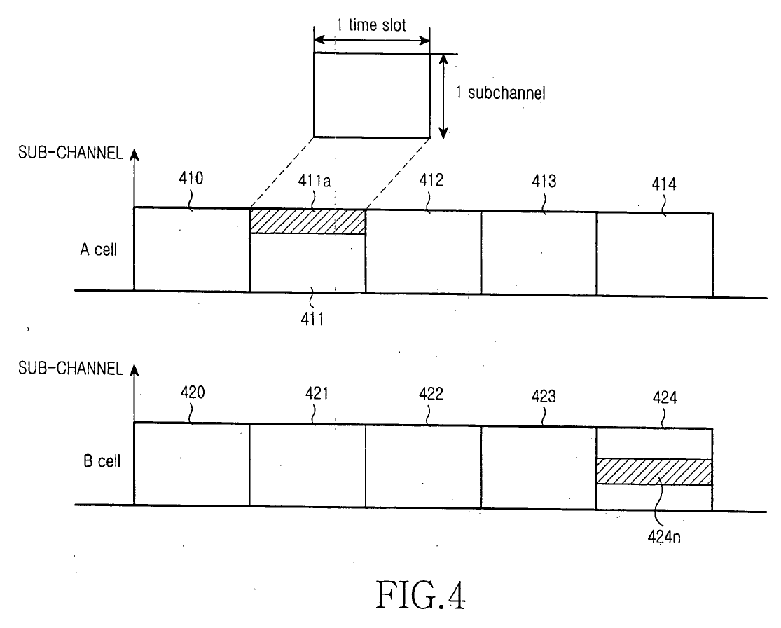

FIG. 4 is a diagram illustrating an allocation of the different sub-channels in the different time slots by BSs and signal transmission based on the allocation according to an embodiment of the present invention. Referring to FIG. 4, a BS of a cell A allocates a sub-channel 411a to n MS in a specific time slot 411 of multiple time slots 410 to 414 in a downlink frame. Further, a BS of a cell B allocates a sub-channel 424n to an MS in a specific time slot 424 of multiple time slots 420 to 424 in a downlink frame. The time slot 411 of the cell A and the time slot 424 of the cell B are different time slots. The sub-channels 411a and 424n allocated to the MS are sub-channels having different frequency resources.

According to the method as described above, the MS receives signals from the different BSs or sectors through the different time slots and the different sub-channels. Further, because the two different BSs do not need to transmit data to be transmitted to the MS located in a handover region in the same time slot, flexibility occurs in a scheduling of each BS and there is no need for quick message transfer between a BS and a Base Station Controller (BSC).

Herein, the MS must receive all allocation information transmitted from each BS.

2. The Soft Handover Method when all BSs Use Different Sub-Channelization Methods

A. Allocation of Different Sub-Channels in the Same Time Slot

Each BS of each cell allocates a specific sub-channel to a MS. The sub-channel allocated to the MS by the BS exists in the same time slot, but is transmitted by means of the different sub-channels. The above-described method may be illustrated in the same manner shown in FIG. 3, except for the difference between the sub-channelization methods of the BSs._ This method has an advantage in that latency is short.

B. Allocation of Different Sub-Channels in Different Time Slots

Each BS of each cell allocates a sub-channel to a MS in a specific time slot of multiple time slots in a downlink frame. The MS receives signals through different time slots and different sub-channels. The above-described method may also be illustrated in the same manner shown in FIG. 4, except for the difference between the sub-channelization methods of the BSs.

According to this method, because the BSs do not need to transmit data in the same time slot, flexibility occurs in a scheduling of each BS. Further, there is no need for quick message transfer between a BS and a BSC. Therefore, this method may correspond to a generalized method of other methods.

In the downlink soft handover method as described above, a MS receives signals transmitted from a plurality of BSs and processes the received signals using a soft combining scheme or a selection diversity scheme.

According to the soft combining scheme, the MS receives the signals transmitted from the BSs, demodulates and combines the received signals, and outputs the combined signals to decoding channel codes. According to the selection diversity scheme, the MS receives the signals transmitted from the BSs, demodulates and decodes the received signals, and selects received signals with the best quality from the decoded data of the received signals.

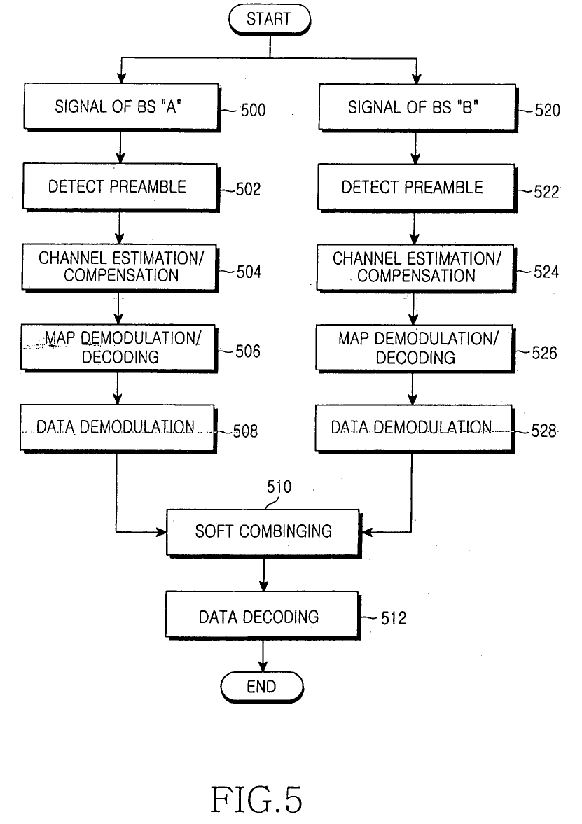

FIG. 5 is a flow diagram illustrating an operation method of a MS in a soft combining scheme during a handover in a BWA communication system according to an embodiment of the present invention. Referring to FIG. 5, in steps 500 and 520, the MS receives signals transmitted from a BS “A” and signals transmitted from a BS “B”. An operation process of the MS when the signals are received from the BS “A” is shown in steps 500, 502, 504, 506, and 508. Further, an operation process of the MS when the signals are received from the BS “B” is shown in steps 520, 522, 524, 526, and 528. The two kinds of signals received from the BSs “A” and “B” are different in that the BSs having transmitted the signals are different from each other. However, because the signals from the BS “A” and the signals from the BS “B” are processed through the same process, the following description will be given with stress on the signals received from the BS “A”. Accordingly, it is noted that the signals received from the BS “B” are processed through a process similar to that through which the signals received from the BS “A” are processed.

In step 500, the MS receives the signals from the BS “A”. In step 502, the MS detects a preamble from the received signals. The preamble represents information located in the first portion of the downlink as described in FIG. 1. In step 504, the MS performs channel estimation and compensation. Herein, it is possible to perform the channel estimation and compensation by using the detected preamble. For example, the MS computes a CINR by using received preamble signals and performs the channel estimation and compensation. That is, because the MS have already known the preamble signals, the MS can perform the channel estimation and compensation by using the preamble.

In step 506, the MS demodulates and decodes a MAP. That is, the MS acquires MAP information by demodulating and decoding the MAP. Accordingly, the MS can understand a location of data allocated to the MS, i.e., data to be transmitted from a BS to the MS, in an entire frame from the MAP information. In step 506, the MS recognizes a location of a frame allocated to the MS by demodulating and decoding data, and receives signals through a time slot and a sub-channel, through which data of the MS is transmitted, by means of the recognized location. In step 508, the MS receives data through a sub-channel including data allocated to the MS, and demodulates the received data.

For the signals received from the BS “B”, the MS demodulates data through the process similar to that through which the signals received from the BS “A” are processed. Accordingly, because the operation of the MS for processing the signals from the BS “B” in steps 520, 522, 524, 526, and 528 is similar to that of the MS for processing the signals from the BS “A” in steps 500, 502, 504, 506, and 508, the detailed description will be omitted here.

As described above, for the signals from the BS “A” and the signals from the BS “B”, the MS demodulates the data in steps 508 and 528. Then, in step 510, the MS performs a soft-combining for the data obtained by demodulating the received signals from the BSs, i.e., the BSs “A” and “B”. In step 512, the MS decodes the data. As a result, the MS processes the signals transmitted from the different BSs through the process as illustrated in FIG. 5.

In order to improve system performance through the soft combining scheme as described above, precise channel estimation must be performed for the signals received from each BS. Accordingly, when the channel estimation is precise, i.e., stable, the system performance can be improved using the soft combining scheme. However, when the channel estimation is unstable, use of the soft combining scheme may deteriorate the system performance. When the MS determines that the channel estimation is unstable, detecting data by means of only BS signals, for which the channel estimation may be relatively stable, instead of the soft combining scheme, may improve the quality of received signals.

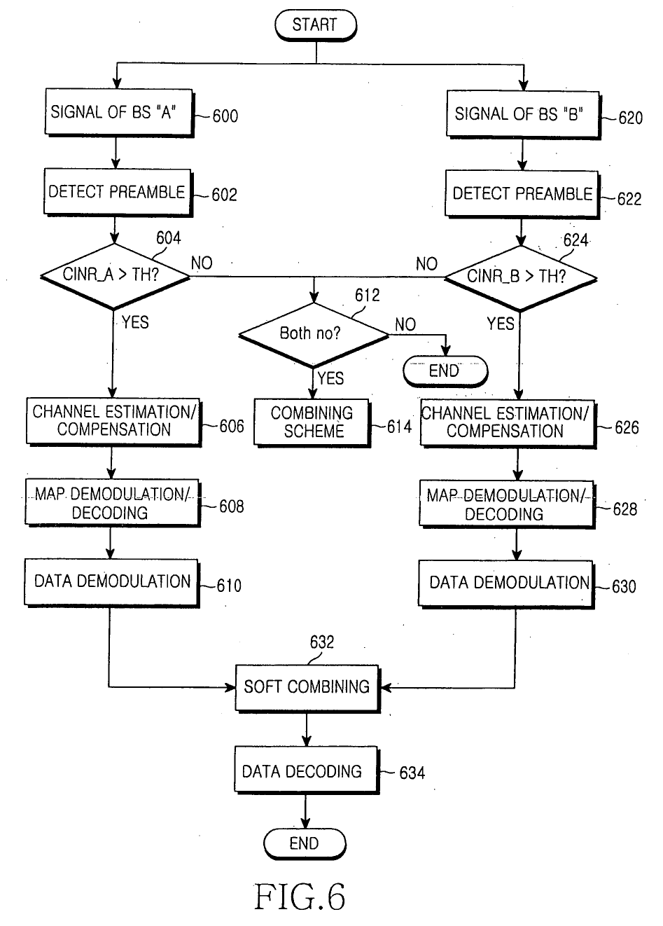

FIG. 6 is a flow diagram illustrating an operation method of an MS in a soft combining scheme in handover in a BWA communication system according to another embodiment of the present invention. Referring to FIG. 6, the operation is similar to that of the MS in the soft combining scheme as illustrated in FIG. 5, and a step of measuring channel quality information and comparing the information with a preset threshold value is inserted between a step of detecting a preamble from BS signals and a channel estimation and compensation step. Further, the MS processes the BS signals based on the comparison result. As compared with FIG. 5, steps 604, 624, 612, and 614 are additionally performed in FIG. 6. That is, if these steps are omitted, FIG. 6 shows a flow similar to that of FIG. 5. Accordingly, the following description will be given with emphasis on steps 604, 624, 612, and 614 and the description on steps similar to those of FIG. 5 will be omitted.

In step 600, the MS receives signals transmitted from a BS “A”. In step 602, the MS detects a preamble from the signals. In step 604, the MS computes a CINR_A value. The CINR_A value denotes a CINR value for the signals received from the BS “A”. In step 604, the MS determines if the CINR value for the signals received from the BS “A” is larger than a preset threshold value. This determination step inspects the reliability of the signals received from the BS “A”. That is, stability or instability of channel estimation is inspected by means of the CINR value.

As a result of the determination, when it is determined that the channel estimation is stable, i.e., when the CINR value for the signals received from the BS “A” exceeds the preset threshold value, step 606 is performed. Because steps 606, 608, and 610 are equal to steps 504, 506, and 508 of FIG. 5, the detailed description of these steps will be omitted.

However, when it is determined that the channel estimation is unstable, i.e., when the CINR value for the signals received from the BS “A” does not exceed the preset threshold value, step 612 is performed.

Further, the MS also performs the same operation for the signals received from the BS “B”. That is, in step 620, the MS receives the signals from the BS “B”. In step 622, the MS detects a preamble from the signals. In step 624, the MS computes a CINR_B value. The CINR_B value denotes a CINR value for the signals received from the BS “B”. In step 624, the MS determines if the CINR value for the signals received from the BS “B” is larger than the preset threshold value.

As a result of the determination, when it is determined that the channel estimation is stable, i.e., when the CINR value for the signals received from the BS “B” exceeds the preset threshold value, step 626 is performed. Again, because steps 626, 628, and 630 are to the same as steps 524, 526, and 528 of FIG. 5, the detailed description of these steps will be omitted.

However, when it is determined that the channel estimation is unstable, i.e., when the CINR value for the signals received from the BS “B” does not exceed the preset threshold value, step 612 is performed.

In step 612, the MS determines if both the CINR_A value and the CINR_B value do not exceed the preset threshold value. When all of the CINR values do not exceed the preset threshold value, step 614 is performed. When all of the CINR values do not exceed the preset threshold value, this indicates that all of the signals received from the BSs are unstable.

In step 614, the MS processes data through one method of signal processing schemes, i.e., combining schemes. Hereinafter, the combining schemes proposed by the present invention will be described.

A first scheme: the MS processes only received signals having the largest value from among channel quality information, i.e., CINR values, measured from a preamble received from each BS, that is, the MS performs demodulation/decoding of a MAP and demodulation/decoding of data.

A second scheme: the MS processes all signals received from BSs, i.e., the MS performs demodulation/decoding of a MAP and demodulation/decoding of data.

A third scheme: the MS processes all signals received from BSs as reception error.

As a result of the determination in step 612, when one of the CINR values exceeds the preset threshold value, the procedure is ended to prevent step 614 from being performed. However, when one of the CINR values does exceed the preset threshold value, the MS performs a signal processing for the signals having the CINR value exceeding the preset threshold value. That is, in step 604 or step 624, when one of the CINR value for the signals received from each of BS exceeds the preset threshold value, the MS performs step 606 or step 626. In steps 610 and 630, the MS performs a data demodulation. In step 632, the MS performs a soft combining for the demodulated data signals. In step 634, the MS performs data decoding.

According to the method of FIG. 6, the MS measures the channel quality information, e.g., the CINR value, using the preamble detected from the signals transmitted from each BS. Further, the MS determines if the channel estimation is stable or unstable using the CINR value. Accordingly, the MS can determine whether to perform the soft combining for the signals transmitted from each BS. When it is determined that the channel estimation is unstable, the MS does not perform the signal processing, i.e., the MAP demodulation/decoding and data demodulation/decoding, for the unstable signals of the BS. Further, the MS does not perform the soft combining for the unstable signals of the BS as described above, thereby preventing the signals from deteriorating.

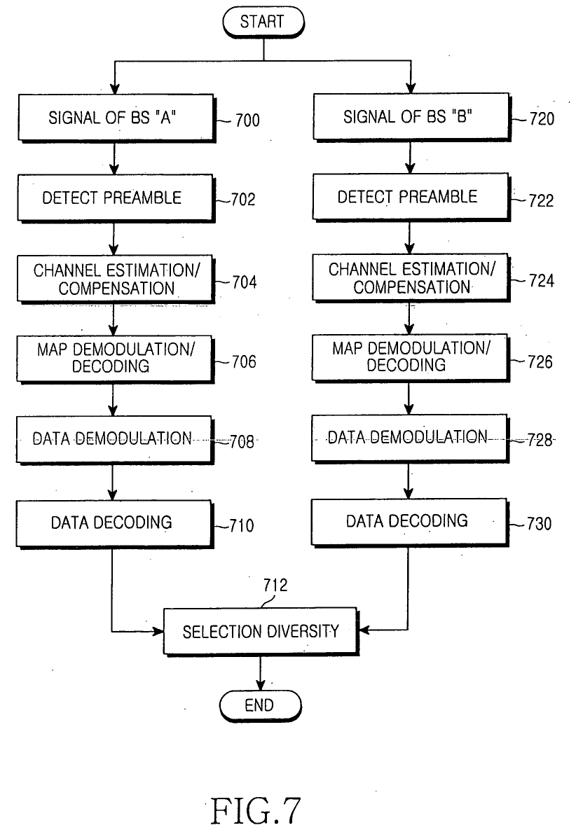

FIG. 7 is a flow diagram illustrating an operation method of an MS in a selection diversity scheme in a handover in a BWA communication system according to another embodiment of the present invention. Referring to FIG. 7, in step 700, the MS receives signals transmitted from a BS “A”. In step 720, the MS receives signals transmitted from a BS “B”. An operation process of the MS when the signals are received from the BS “A” is shown in steps 700, 702, 704, 706, 708, and 710. Further, an operation process of the MS when the signals are received from the BS “B” is shown in steps 720, 722, 724, 726, 728, and 730. The two kinds of signals received from the BSs “A” and “B” are different in that the BSs having transmitted the signals are different from each other. However, because the signals from the BS “A” and the signals from the BS “B” are processed through the same process, the following description will be given with emphasis on the signals received from the BS “A”.

As indicated above, in step 700, the MS receives the signals from the BS “A”. In step 702, the MS detects a preamble from the received signals. In step 704, the MS performs channel estimation and compensation by means of the detected preamble. The channel estimation and compensation is performed as described in FIG. 5.

In step 706, the MS demodulates and decodes a MAP. That is, the MS acquires MAP information by demodulating and decoding the MAP. Accordingly, the MS can understand a location of data allocated to the MS, i.e., data to be transmitted from a BS to the MS, in an entire frame from the MAP information. In step 706, the MS recognizes a location of a frame allocated to the MS by demodulating and decoding data, and receives signals through a time slot and a sub-channel, through which data of the MS are transmitted, by means of the recognized location. In step 708, the MS receives data through a sub-channel including data allocated to the MS, and demodulates the received data. In step 710, the MS decodes the demodulated data.

For the signals received from the BS “B”, the MS demodulates data through the process similar to that through which the signals received from the BS “A” are processed. Accordingly, because the operation of the MS for processing the signals from the BS “B” in steps 720, 722, 724, 726, 728, and 730 is similar to that of the MS for processing the signals from the BS “A” in steps 700, 702, 704, 706, 708, and 710, the detailed description will be omitted here.

In steps 710 and 730, the MS decodes the data of the signals from the BS “A” and the signals from the BS “B”. The signals processed through the steps pass through step 712. In step 712, the MS performs selection diversity. Accordingly, the MS selects favorable data of the signals received from the BSs using the selection diversity scheme. The selection of the favorable data can be confirmed through a CRC check for checking if decoded data have been normally received.

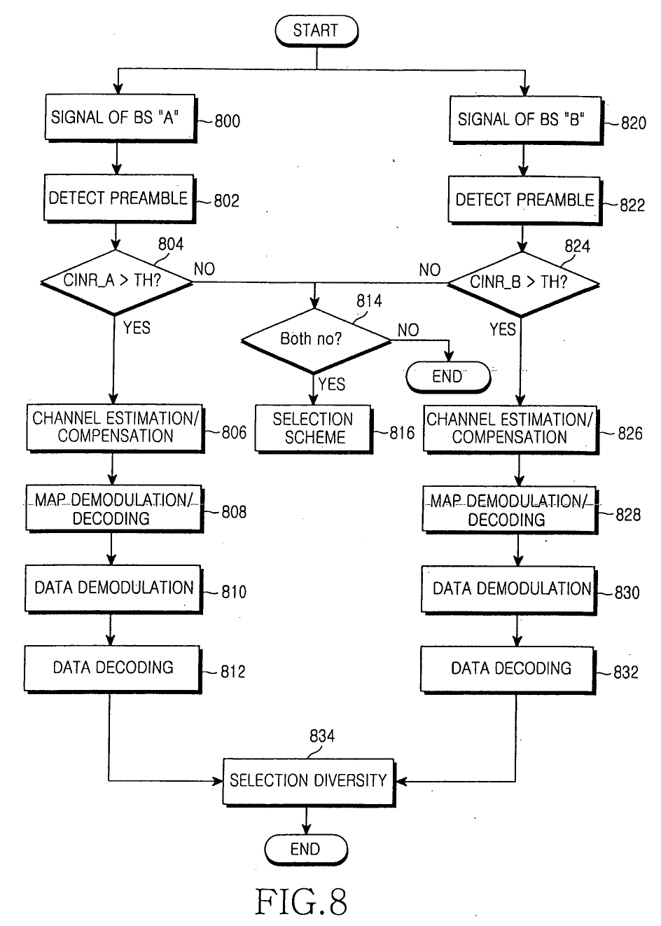

FIG. 8 is a flow diagram illustrating an operation method of a MS in the selection diversity scheme in handover in a BWA communication system according to another embodiment of the present invention. Referring to FIG. 8, the operation is similar to that of the MS in the selection diversity scheme as illustrated in FIG. 7, and a step of measuring channel quality information and comparing the information with a preset threshold value is inserted between a step of detecting a preamble from BS signals and a channel estimation and compensation step. The BS signals are processed based on the comparison result. As compared with FIG. 7, steps 804, 824, 814, and 816 are additionally performed in FIG. 8. That is, if these steps are omitted, FIG. 8 shows a flow similar to that of FIG. 7. Accordingly, the following description will be given with emphasis on steps 804, 824, 814, and 816 and the description on steps similar to those of FIG. 7 will be omitted.

In step 800, the MS receives signals transmitted from a BS “A”. In step 802, the MS detects a preamble from the signals. In step 804, the MS computes a CINR_A value. The CINR_A value denotes a CINR value for the signals received from the BS “A”. In step 804, the MS determines if the CINR value for the signals received from the BS “A” is larger than a preset threshold value. This determination step inspects the reliability of the signals received from the BS “A”. That is, stability or instability of channel estimation is inspected by means of the CINR value.

When it is determined that the channel estimation is stable, i.e., when the CINR value for the signals received from the BS “A” exceeds the preset threshold value, step 806 is performed. Because steps 806, 808, 810, and 812 after step 804 are to the same as steps 704, 706, 708, and 710 of FIG. 7, the detailed description these steps will be omitted.

However, when it is determined that the channel estimation is unstable, i.e., when the CINR value for the signals received from the BS “A” does not exceed the preset threshold value, step 814 is performed.

Further, the MS performs the same operation for the signals received from the BS “B”. That is, in step 820, the MS receives the signals from the BS “B”. In step 822, the MS detects a preamble from the signals. In step 824, the MS computes a CINR_B value. The CINR_B value denotes a CINR value for the signals received from the BS “B”. In step 824, the MS determines if the CINR value for the signals received from the BS “B” is larger than the preset threshold value.

When it is determined that the channel estimation is stable, i.e., when the CINR value for the signals received from the BS “B” exceeds the preset threshold value, step 826 is performed. Because steps 826, 828, 830, and 832 are to the same as steps 724, 726, 728, and 730 of FIG. 7, the detailed description of these steps will be omitted.

However, when it is determined that the channel estimation is unstable, i.e., when the CINR value for the signals received from the BS “B” does not exceed the preset threshold value, step 814 is performed.

In step 814, the MS determines if both the CINR_A value and the CINR_B value do not exceed the preset threshold value. When all of the CINR values do not exceed the preset threshold value, step 816 is performed. When all of the CINR values do not exceed the preset threshold value, this indicates that all of the signals received from the BSs are unstable. In step 816, the MS processes data through one method of signal processing schemes, i.e., selecting schemes, which have been described above.

Hereinafter, the combining schemes proposed by the present invention will be described.

A first scheme: the MS processes only received signals having the largest value from among channel quality information, i.e., CINR values, measured from a preamble received from each BS, that is, the MS performs demodulation/decoding of a MAP and demodulation/decoding of data.

A second scheme: the MS processes all signals received from BSs, that is, the MS performs demodulation/decoding of a MAP and demodulation/decoding of data.

A third scheme: the MS processes all signals received from BSs as reception error.

As a result of the determination in step 814, when one of the CINR values exceeds the preset threshold value, the procedure is ended so as to prevent step 816 from being performed. However, when one of the CINR values does not exceed the preset threshold value, the MS performs a signal processing for the signals having the CINR value exceeding the preset threshold value. In other words, in step 804 or step 824, when one of the CINR value for the signals received from each of BS exceeds the preset threshold value, the MS performs step 806 or step 826 performed.

In step 834, the MS performs selection diversity for the decoded data using the selection diversity scheme. Therefore, the MS can use selectively received signals through the operation as illustrated in FIG. 8 according to the reliability of the signals received from the BSs.

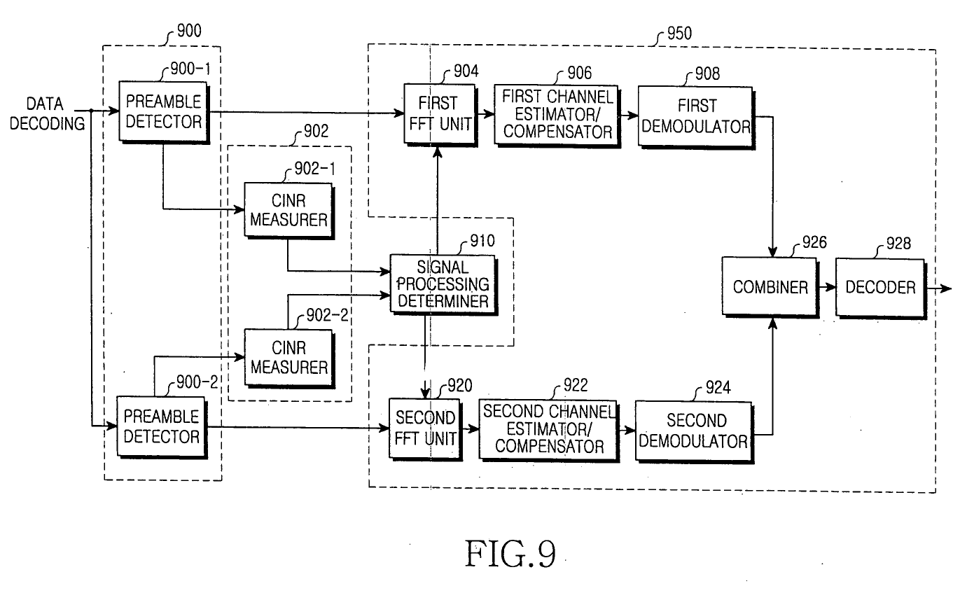

Referring to FIG. 6 and FIG. 8, described preset threshold values can have each of identical value or different value. For example in step 604 and in step 624(or step 804 and step 824), the preset threshold values can identical or different. FIG. 9 is a block diagram illustrating an MS in a soft combining scheme in a handover in a BWA communication system according to an embodiment of the present invention. Referring to FIG. 9, the MS includes a preamble detector 900, a CINR measurer 902, a signal processing determiner 910, and a signal processor 950. The Signal processor 950 includes a first Fast Fourier Transform (FFT) unit 904, a second FFT unit 920, a first channel estimator/compensator 906, a second channel estimator/compensator 922, a first demodulator 908, a second demodulator 924, a combiner 926, and a decoder 928.

The preamble detector 900 receives signals from BSs and detects preambles from the received signals. The signals received through an antenna are signals that have passed through a Radio Frequency (RF) processing and an analog/digital conversion. In more detail, a first preamble detector 900-1 of the preamble detector 900 receives the signals from the BS “A” and detects the preamble from the received signals, and a second preamble detector 900-2 of the preamble detector 900 receives the signals from the BS “B” and detects the preamble from the received signals. Accordingly, the MS acquires frequency synchronization and time synchronization by detecting the preambles.

The first FFT unit 904 receives signals output from the preamble detector 900 and performs an FFT for the received signals. The first channel estimator/compensator 906 receives signals output from the first FFT unit 904 and performs channel estimation and compensation for the received signals. The first demodulator 908 receives signals output from the first channel estimator/compensator 906 and performs a data demodulation for the received signals.

The second FFT unit 920, the second channel estimator/compensator 922 and the second demodulator 924 perform operations equal to those of the first FFT unit 904, the first channel estimator/compensator 906, and the first demodulator 908, respectively. The difference is that the second FFT unit 920, the second channel estimator/compensator 922, and the second demodulator 924 process the signals received from the BS “B”.

The combiner 926 receives signals output from the first demodulator 908 and the second demodulator 924 and performs a soft combining for the received signals. That is, the combiner 926 combines the signals output from the demodulators by means of the soft combining scheme. The decoder 928 receives signals output from the combiner 926 and performs data decoding for the received signals.

Accordingly, the above-described MS can perform the method as illustrated in FIG. 5.

The CINR measurer 902 receives signals output from the preamble detector 900 and measures channel quality information, i.e., CINR values, from the preamble. Accordingly, the CINR measurer 902 may be referred to as a channel quality information measurer. More specifically, a first CINR measurer 902-1 of the CINR measurer 902 measures the CINR value from the preamble detected from the signals of the BS “A”, and a second CINR measurer 902-2 of the CINR measurer 902 measures the CINR value from the preamble detected from the signals of the BS “B”.

The signal processing determiner 910 receives signals output from the CINR measurer 902 and compares the CINR values with a preset threshold value. When the CINR values exceed the preset threshold value, the signal processing determiner 910 determines a signal processing. Further, the signal processing determiner 910 outputs control signals or operation signals to the first FFT unit 904 and the second FFT unit 920 based on the determination about whether to perform the signal processing, thereby controlling the processing for the signals of the BSs.

When all of the CINR values do not exceed the preset threshold value, as illustrated in FIG. 6, the signal processing determiner 910 may have a predetermined operation scheme or it is possible to set the signal processing determiner 910 to have the predetermined operation scheme.

Accordingly, when the CINR values measured from the preambles are larger than the preset threshold value, the signal processing determiner 910 may process only the received signals of the BS having the largest value from among the CINR values, process all signals received from the BSs, or process all signals of the BSs as error. Accordingly, the signal processing determiner 910 can determine if the signals of the BSs are proper for the soft combining and performs operations based on the determination.

The preamble detector 900 or the CINR measurer 902 may be constructed by separate modules as illustrated in FIG. 9, but may also be constructed by one module.

The first FFT unit 904, the first channel estimator/compensator 906, the first demodulator 908, the second FFT unit 920, the second channel estimator/compensator 922, and the second demodulator 924 are also illustrated in FIG. 9 in order to perform the operations for processing the signals of the BSs. Accordingly, modules performing the same operations may be constructed by one module or may be separately constructed. That is, the structure of the MS is not limited to that as illustrated in FIG. 9.

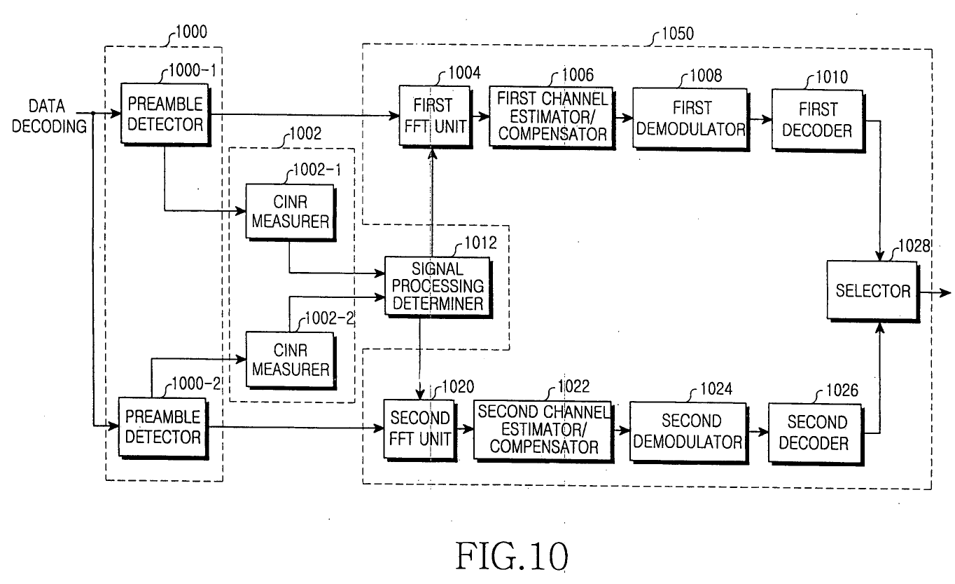

FIG. 10 is a block diagram illustrating an MS in a selection diversity scheme in a handover in a BWA communication system according to another embodiment of the present invention. Referring to FIG. 10, the MS includes a preamble detector 1000, a CINR measurer 1002, a signal processing determiner 1012, and a signal processor 1050. The Signal processor 1050 includes a first FFT unit 1004, a second FFT unit 1020, a first channel estimator/compensator 1006, a second channel estimator/compensator 1022, a first demodulator 1008, a second demodulator 1024, a first decoder 1010, a second decoder 1026, and a selector 1028.

The preamble detector 1000 receives signals from BSs and detects preambles from the received signals. The signals received through an antenna are regarded as signals having passed through an RF processing and an analog/digital conversion. More specifically, a first preamble detector 1000-1 of the preamble detector 1000 receives the signals from the BS “A” and detects the preamble from the received signals, and a second preamble detector 1000-2 of the preamble detector 1000 receives the signals from the BS “B” and detects the preamble from the received signals. Accordingly, the MS acquires frequency synchronization and time synchronization by detecting the preambles. The first FFT unit 1004 receives signals output from the preamble detector 1000 and performs an FFT for the received signals. The first channel estimator/compensator 1006 receives signals output from the first FFT unit 1004 and performs channel estimation and compensation for the received signals. The first demodulator 1008 receives signals output from the first channel estimator/compensator 1006 and performs a data demodulation for the received signals.

The second FFT unit 1020, the second channel estimator/compensator 1022, the second demodulator 1024 and the second decoder 1026 perform operations equal to those of the first FFT unit 1004, the first channel estimator/compensator 1006, the first demodulator 1008, and the first decoder 1010, respectively. The difference is that the second FFT unit 1020, the second channel estimator/compensator 1022, the second demodulator 1024, and the second decoder 1026 process the signals received from the BS “B”.

The selector 1028 receives signals output from the first decoder 1010 and the second decoder 1026 and performs selection diversity for the received signals. That is, the selector 1028 selects predetermined signals from the output signals of the decoders using the selection diversity scheme.

Accordingly, the above-described MS can perform the method as illustrated in FIG. 7.

The CINR measurer 1002 receives signals output from the preamble detector 1000 and measures channel quality information, i.e., CINR values, from the preamble. Accordingly, the CINR measurer 1002 may be referred to as a channel quality information measurer. More specifically, a first CINR measurer 1002-1 of the CINR measurer 1002 measures the CINR value from the preamble detected from the signals of the BS “A”, and a second CINR measurer 1002-2 of the CINR measurer 1002 measures the CINR value from the preamble detected from the signals of the BS “B”.

The signal processing determiner 1012 receives signals output from the CINR measurer 1002 and compares the CINR values with a preset threshold value. When the CINR values exceed the preset threshold value, the signal processing determiner 1012 determines a signal processing. Further, the signal processing determiner 1012 outputs control signals or operation signals to the first FFT unit 1004 and the second FFT unit 1020 based on the determination about whether to perform the signal processing, thereby controlling the processing for the signals of the BSs.

When all of the CINR values do not exceed the preset threshold value, as illustrated in FIG. 8, the signal processing determiner 1012 may have a predetermined operation scheme or it is possible to set the signal processing determiner 1012 to have the predetermined operation scheme.

Accordingly, when the CINR values measured from the preambles are larger than the preset threshold value, the signal processing determiner 1012 may process only the received signals of the BS having the largest value from among the CINR values, process all signals received from the BSs, or process all signals of the BSs as error. Accordingly, the signal processing determiner 1012 can determine if the signals of the BSs are proper for the selection diversity and performs operations based on the determination.

The preamble detector 1000 or the CINR measurer 1002 may be constructed by separate modules as illustrated in FIG. 10, but it may be constructed by one module.

The first FFT unit 1004, the first channel estimator/compensator 1006, the first demodulator 1008, the first decoder 1010, the second FFT unit 1020, the second channel estimator/compensator 1022, the second demodulator 1024, and the second decoder 1026 are also illustrated in FIG. 10 in order to perform the operations for processing the signals of the BSs. Accordingly, modules performing the same operations may be constructed by one module or may be separately constructed. That is, the structure of the MS is not limited to that as illustrated in FIG. 10.

As described above, the present invention enables a MS to process signals of BSs using a soft combining scheme and a selection diversity scheme in a handover in a BWA communication system. Further, according to the present invention, it is possible to determine a method for processing signals received from BSs using channel quality information, i.e., CINR values, of the signals.

Furthermore, the present invention enables a MS to flexibly operate based on channel conditions in handover, thereby efficiently processing received signals and preventing reception performance from deteriorating due to deterioration of the channel conditions.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A method for processing received signals in a handover of a Mobile Station (MS) in a Broadband Wireless Access (BWA) communication system including a plurality of Base Stations (BSs) capable of providing a service to the MS, the method comprising the steps of:
receiving signals of different BSs;
detecting preambles for each BS from the received signals;
measuring channel quality information corresponding to each of the detected preambles;
comparing the measured channel quality information with a preset threshold value; and
processing the signals received from the different BSs based on a result obtained by comparing the measured channel quality information with the preset threshold value.

2. The method as claimed in claim 1, wherein the channel quality information includes a Carrier-to-Interference and Noise Ratio (CINR).

3. The method as claimed in claim 1, further comprising the step of processing all of the signals received from the BSs, when the channel quality information exceeds all of each the preset threshold value.

4. The method as claimed in claim 1, further comprising the step of processing signals received from a specific BS, when only channel quality information corresponding to a preamble extracted from the specific BS exceeds the preset threshold value.

5. The method as claimed in claim 1, further comprising the step of selectively processing the signals received from the BSs according to a predetermined signal processing scheme, when the channel quality information does not exceed the preset threshold value.

6. The method as claimed in claim 5, wherein the signal processing scheme processes only signals of a specific BS having a largest value from among the channel quality information corresponding to each preamble detected from the signals received from each of the BSs.

7. The method as claimed in claim 5, wherein the signal processing scheme processes all of the signals received from the BSs.

8. The method as claimed in claim 5, wherein the signal processing scheme processes all of the signals received from the BSs as errors.

9. The method as claimed in claim 1, wherein the step of processing the signals comprises the step of processing the signals received from the different BSs based on a soft combining scheme.

10. The method as claimed in claim 1, wherein the step of processing the signals comprises the step of processing the signals received from the different BSs based on a selection diversity scheme.

11. A method for processing received signals in a handover of a Mobile Station (MS) in a Broadband Wireless Access (BWA) communication system including a plurality of Base Stations (BSs) capable of providing a service to the MS, the method comprising the steps of:
receiving signals of different BSs;
detecting preambles for each of the BSs from the received signals;
measuring a first measurement value and a second measurement value corresponding to each of the detected preambles;
comparing each of the measurement values with a preset threshold value;
processing all of the signals received from the BSs, when the first measurement value and the second measurement value exceed the preset threshold value; and
selectively processing the signals received from the BSs according to a predetermined signal processing scheme, when the first measurement value and the second measurement value do not exceed the preset threshold value.

12. The method as claimed in claim 11, wherein the measurement value includes a Carrier-to-Interference and Noise Ratio (CINR).

13. The method as claimed in claim 11, further comprising the step of:
when one of the first measurement value and the second measurement value exceeds the preset threshold value, processing signal received from a BS having the measurement value exceeding the preset threshold value.

14. The method as claimed in claim 11, wherein the signal processing scheme processes only signals of a specific BS having a largest value from among the channel quality information corresponding to each preamble detected from the signals received from each of the BSs.

15. The method as claimed in claim 11, wherein the signal processing scheme processes all of the signals received from the BSs.

16. The method as claimed in claim 11, wherein the signal processing scheme processes all of the signals received from the BSs as errors.

17. The method as claimed in claim 11, wherein the step of processing the signals comprises the step of processing the signals received from the different BSs based on a soft combining scheme.

18. The method as claimed in claim 11, wherein the step of processing the signals comprises the step of processing the signals received from the different BSs based on a selection diversity scheme.

19. An apparatus for processing received signals in a handover in a Broadband Wireless Access (BWA) communication system including a plurality of Base Stations (BSs) capable of providing a service to the MS, the apparatus comprising:
a preamble detector for receiving signals of different BSs and detecting preambles for each of the BSs from the received signals;
a channel quality information measurer for measuring channel quality information corresponding to each of the detected preamble;
a signal processing determiner for comparing the measured channel quality information with a preset threshold value, and determining whether to process the signals received from the different BSs based on a result obtained by comparing the measured channel quality information with the preset threshold value; and
a signal processor for processing the signals received from the different BSs, based on whether to process the signals.

20. The apparatus as claimed in claim 19, wherein the channel quality information includes a Carrier-to-Interference and Noise Ratio (CINR).

21. The apparatus as claimed in claim 19, wherein the signal processing determiner determines of processing the signals received from the BSs when the channel quality information exceeds the preset threshold value.

22. The apparatus as claimed in claim 19, wherein the signal processing determiner determines of processing signals received from a specific BS when only channel quality information corresponding to a preamble extracted from the specific BS exceeds the preset threshold value.

23. The apparatus as claimed in claim 19, wherein the signal processing determiner determines of selectively processing the signals received from the BSs according to a predetermined signal processing scheme when the channel quality information does not exceed the preset threshold value.

24. The apparatus as claimed in claim 23, wherein the signal processing scheme processes only signals of a specific BS having a largest value from among the channel quality information corresponding to each preamble detected from the signals received from each of the BSs.

25. The apparatus as claimed in claim 23, wherein the signal processing scheme processes all of the signals received from the BSs.

26. The apparatus as claimed in claim 23, wherein the signal processing scheme processes all of the signals received from the BSs as errors.

27. The apparatus as claimed in claim 19, wherein the signal processor includes a combiner using a soft combining scheme.

28. The apparatus as claimed in claim 19, wherein the signal processor comprises a selector using a selection diversity scheme.
